(19) United States
(12) Patent Application Publication
(10) Pub. No.: US 2021/0319524 A1
(43) Pub. Date: Oct. 14, 2021

(54) SYSTEMS, APPARATUSES, AND METHODS FOR MATCHING REAL ESTATE BUYER WITH USER

(71) Applicant: WOOLLEY ROBERTSON GROUP, INC., Huntington Beach, CA (US)

(72) Inventors: Dan Woolley, Huntington Beach, CA (US); Gregory Robertson, Huntington Beach, CA (US)

(21) Appl. No.: 17/273,454

(22) PCT Filed: Sep. 6, 2019
(86) PCT No.: PCT/US2019/050001

§ 371 Date: Mar. 4, 2021

Related U.S. Application Data
(60) Provisional application No. 62/728,620, filed on Sep. 7, 2018.

(51) Int. Cl. G06Q 50/16; G06Q 30/06; G06Q 30/02

(52) U.S. Cl. CPC G06Q 50/16; G06Q 30/0201; G06Q 30/0619

(57) ABSTRACT

Systems, apparatuses, and methods for matching a user with a real estate buyer. A method may include determining whether one or more real estate property characteristics provided for a comparative market analysis meet one or more real estate buyer criteria of the real estate buyer. The method may include matching the user with the real estate buyer based on a response to a query. Additional queries may comprise specifics provided by a real estate buyer.

### CROSS REFERENCE TO RELATED APPLICATIONS

This application claims the benefit of U.S. Provisional Application No. 62/728,620, filed Sep. 7, 2018, the entire contents of which are incorporated by reference herein.

### BACKGROUND

Computerized methods have been developed to assist real estate owners in selling real estate. For example, online systems may enhance the availability of information regarding which properties are for sale and what a reasonable selling or “market” price may be. A buyer of real estate may be able to access such an online system and view a neighborhood or other region to determine what properties are for sale.

However, such computerized methods often fail to address difficulties of a real estate owner in actually engaging in the process of listing the property and closing a transaction on the property. In addition, such computerized methods continue to fail to actually match a real estate buyer with a user of a computerized method such as a real estate professional.

### SUMMARY

Improvements are accordingly desired in the field of listing a real estate property and closing a transaction on the property. Improvements may accordingly be desired in the field of matching a real estate buyer with a user of a computerized method such as a real estate professional. Such improvements may be directed to enhancing the ability of a user, such as a real estate professional, to produce a comparative market analysis and a comparative market analysis report that may be used to win a listing from a real estate owner and generate a cash offer for the property in question before, during, or after a listing presentation.

Systems, apparatuses, and methods disclosed herein may be directed to an improved computerized method of processing information provided in a comparative market analysis, and querying a user such as a real estate professional regarding whether such user may want an offer on a property from a real estate buyer. The real estate buyer may be an iBuyer, and may be prepared to present a cash offer to the user for the user to present to a real estate owner during a listing presentation. Systems, apparatuses, and methods disclosed herein may match the user with the real estate buyer prior, during, or after attending the listing presentation. The user may be able to attend the listing presentation with a comparative market analysis report as well as an offer from the real estate buyer to present to the real estate owner. The real estate buyer may benefit by becoming aware of the property for sale that match certain real estate buyer criteria. The user may benefit by utilizing a computerized method to create a comparative market analysis report and presenting an offer to a real estate owner before, during, or after a listing presentation. The real estate owner may benefit by being presented with an offer to purchase the real estate property at an early stage of the sales and listing process.

The real estate buyer may include, but is not limited to an investment broker, investor representative, investor group, individual investor, or broker investor, among others.

The methods disclosed herein may not only be utilized with current real estate properties for sale, but may also be utilized by a user with expired or dead real estate listings. For example, the user may determine potential real estate buyers in the expired or dead property.

A method as disclosed herein may include a method of matching a user with a real estate buyer. The method may include determining, with a processor, whether one or more real estate property characteristics provided for a comparative market analysis meet one or more real estate buyer criteria of the real estate buyer. The method may include querying the user based on the determination. The method may include receiving a response to the query by the user. The method may include matching the user with the real estate buyer based on the response to the query.

A system as disclosed herein may include a system for matching a user with a real estate buyer. The system may comprise a server configured to determine whether one or more real estate property characteristics provided for a comparative market analysis meet one or more real estate buyer criteria of the real estate buyer. The system may be configured to communicate a query to a user device based on the determination. The system may be configured to receive a response to the query by the user device. The system may be configured to match the user with the real estate buyer based on the response to the query.

A non-transitory computer readable medium as disclosed herein may be configured to store a program causing a processor to execute a process. The process may comprise determining whether one or more real estate property characteristics provided for a comparative market analysis meet one or more real estate buyer criteria of a real estate buyer. The process may comprise querying a user based on the determination. The process may comprise receiving a response to the query by the user. The process may comprise matching the user with the real estate buyer based on the response to the query.

### BRIEF DESCRIPTION OF THE DRAWINGS

Features and advantages of the systems, apparatuses, and methods as disclosed herein will become appreciated as the same become better understood with reference to the specification, claims, and appended drawings wherein:

FIG. 1 illustrates a schematic view of participants of a method, according to an embodiment of the present disclosure.

FIG. 2 illustrates a flow chart of a method, according to an embodiment of the present disclosure.

FIG. 3 illustrates a schematic view of a system, according to an embodiment of the present disclosure.

FIG. 4 illustrates a form, according to an embodiment of the present disclosure.

FIG. 5 illustrates a flow chart of a method, according to an embodiment of the present disclosure.

FIG. 6 illustrates a representation of a method, according to an embodiment of the present disclosure.

FIG. 7 illustrates a page of a comparative market analysis report, according to an embodiment of the present disclosure.

FIG. 8 illustrates a page of a comparative market analysis report, according to an embodiment of the present disclosure.

FIG. 9 illustrates a page of a comparative market analysis report, according to an embodiment of the present disclosure.

FIG. 10 illustrates a page of a comparative market analysis report, according to an embodiment of the present disclosure.

FIG. 11 illustrates a page of a comparative market analysis report, according to an embodiment of the present disclosure.

FIG. 12 illustrates a page of a comparative market analysis report, according to an embodiment of the present disclosure.

FIG. 13 illustrates a page of a comparative market analysis report, according to an embodiment of the present disclosure.

FIG. 14 illustrates a page of a comparative market analysis report, according to an embodiment of the present disclosure.

FIG. 15 illustrates a query appearing on a form, according to an embodiment of the present disclosure.

### DETAILED DESCRIPTION

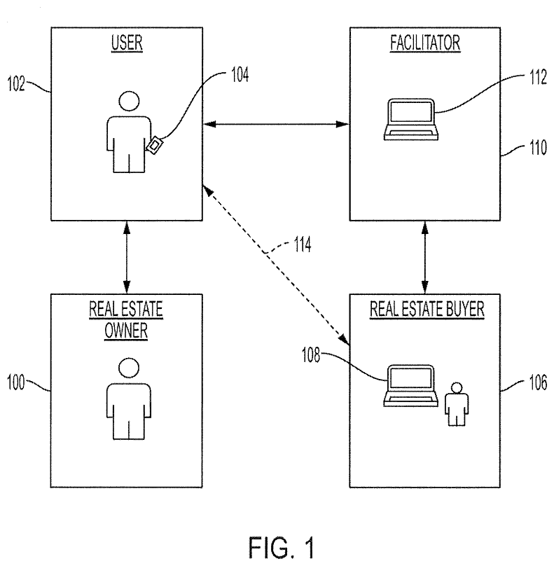

FIG. 1 illustrates an embodiment of participants of a method disclosed herein. The participants may include a real estate owner 100. The real estate owner 100 may be the owner of a real estate property and may include an entity, an individual, or multiple entities or individuals. The real estate property may be a residential property, or a commercial property. However, according to embodiments herein the real estate property may preferably be a residential property.

A participant as shown in FIG. 1 may include a user 102. The user 102 may include an entity, an individual, or multiple entities or individuals. The user 102 may be the user of the systems, apparatuses, and methods disclosed herein.

The user 102 may be a seller of the real estate property owned by the real estate owner 100. For example, the user 102 may be tasked with marketing, offering and/or selling the real estate property on the real estate owner's 100 behalf. The user 102 may be a real estate professional, which may include a real estate broker, real estate agent, or realtor, or an individual working on such broker's, agent's, or realtor's behalf. The user 102 may be a listing agent for the real estate property to be sold on the real estate owner's 100 behalf.

The user 102 may utilize a user device 104. The user device 104 may comprise a mobile computing device (e.g., a mobile phone, a tablet, a laptop), a desktop computer, or other form of computer device. The user device 104 may be configured for the user 102 to utilize to perform the methods disclosed herein.

The user 102 may be associated with the real estate owner 100 to assist the real estate owner 100 in finding a buyer for the owner's 100 real estate property. The user 102 may perform all or a portion of the methods disclosed herein prior to being formally engaged by the real estate owner 100 to market, offer and/or sell the real estate property on the real estate owner's 100 behalf. For example, the user 102 may perform all or a portion of the methods disclosed herein to persuade the real estate owner 100 to formally engage the user 102. The user 102 may perform all or a portion of the methods disclosed herein in a presentation to the owner 100 to persuade the owner 100 to formally engage the user 102 and for example to serve as the owner's listing agent for the real estate property to be sold.

In one embodiment, the user 102 may utilize the methods disclosed herein to receive an offer on a property and present such offer to the real estate owner before, during, or after a listing presentation to the real estate owner.

The user 102 may also be able to represent a real estate buyer 106 on the buyer side of a transaction involving the real estate property. The user 102 may engage the real estate buyer 106 to represent the buyer 106 upon being matched with the buyer 106 according to methods herein.

A participant as shown in FIG. 1 may include a real estate buyer 106. The real estate buyer 106 may include an entity, an individual, or multiple entities or individuals. The real estate buyer 106 may be a prospective or actual buyer of the real estate property owned by the real estate owner 100. According to the methods disclosed herein, the real estate buyer 106 may be a prospective buyer of the real estate property owned by the real estate owner 100 during all or a portion of the methods disclosed herein.

The real estate buyer 106 may utilize a computer device 108. The computer device 108 may comprise a mobile computing device (e.g., a mobile phone, a tablet, a laptop), a desktop computer, or other form of computer device. The computer device 108 may be configured for the real estate buyer 106 to utilize to perform the methods disclosed herein.

The real estate buyer 106 may be a buyer for investment purposes of the real estate property owned by the real estate owner. Thus, the real estate buyer 106 may not actually live in the real estate property (for residential property), or utilize the real estate property (for commercial property) upon purchasing the property. Rather, the real estate buyer 106 may be a buyer of the real estate property for purposes of financial gain, and may be interested in selling the real estate property again for a profit over the amount paid by the real estate buyer 106 for the property.

In embodiments, the real estate buyer 106 may be an iBuyer for the real estate property. An iBuyer may be a buyer that utilizes automated valuation models (AVMs) and other technology to make a relatively prompt offer on a real estate property and close the purchase transaction on the real estate property. The iBuyer may utilize an algorithm to set a purchase price for the real estate property and to make an offer on the real estate property. Should the real estate owner accept, the iBuyer may pay the real estate owner in cash, may repair the real estate property if needed, and may relatively promptly place the real estate property on the market for sale again. The iBuyer may be a buyer that may relatively quickly close the transaction on the real estate property and may sell the real estate property relatively quickly, to provide convenience in the sales transaction for the real estate owner 100 (whether by reducing the time of the sales transaction and/or reducing the complexity of the sales transaction, among other convenience factors). Non-limiting examples of iBuyers may include such current entities as OpenDoor™, Knock™, and Zillow™.

The iBuyer may make an offer that is less than the market price for the real estate property. The real estate owner 100 however, may be attracted to the offer provided by the iBuyer for multiple reasons. For example, the real estate owner 100 may have entered into an agreement to purchase another real estate property contingent on the sale of the real estate property at issue. The real estate owner 100 may be incentivized to relatively promptly sell the real estate property at issue to the iBuyer. Another reason may include the real estate owner 100 may need to relocate relatively promptly for work or another obligation requiring the real estate owner 100 to move. Another reason may include the real estate owner 100 becoming divorced and needing to relatively promptly sell the property. Another reason may include the real estate owner 100 inheriting the real estate property and wanting to relatively promptly sell the property. Another reason may include the real estate owner 100 not wanting to go through the process of publicly displaying the real estate property at issue for sale to others. Any or all reasons may provide an inventive for the real estate owner 100 to accept an offer provided by an iBuyer, among other scenarios.

In other embodiments, the real estate buyer 106 may not comprise an iBuyer, and may comprise another form of real estate buyer. The real estate buyer 106 may include, but is not limited to an investment broker, investor representative, investor group, individual investor, or broker investor, among others.

A participant as shown in FIG. 1 may include a facilitator 110. The facilitator 110 may include a computer device, which may comprise a server 112. In other embodiments, the facilitator 110 may comprise other forms of computer devices. The facilitator 110 may be configured to match the real estate buyer 106 with the user 102 according to the methods herein.

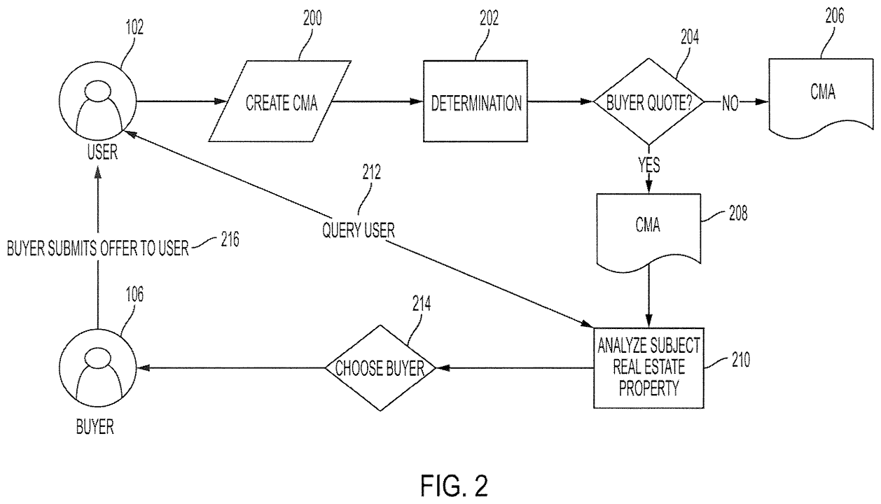

FIG. 2 illustrates a flow chart according to embodiments of the present disclosure. The flow chart may disclose a method of matching a real estate buyer 106 with the user 102. The flow chart may start at the upper left portion of the chart indicated by “user 102.” As discussed, the user 102 may be tasked with marketing, offering and/or selling the real estate property on the real estate owner's 100 behalf. At this point in the flow chart, the user 102 may not have been formally engaged by the real estate owner 100 to market, offer and/or sell the real estate property on the real estate owner's 100 behalf. Rather, the user 102 may be interested in preparing a presentation to the owner 100 to persuade the owner 100 to formally engage the user 102 and for example to serve as the owner's listing agent for the real estate property to be sold. Thus, the user 102 may initiate a step 200 of providing a comparative market analysis report (indicated by reference numbers 206 and 208 in FIG. 2) for the user 102.

The user 102 may initiate the step 200 of providing a comparative market analysis report for the user 102 by providing information to the facilitator 110. The information, for example, may comprise one or more real estate property characteristics of a real estate property. The one or more real estate property characteristics may be provided for the comparative market analysis. The one or more real estate property characteristics may be characteristics of the real estate property owned by the real estate owner 100.

The user 102 may provide such characteristics to generate a comparative market analysis report (206 and 208) that may be presented to the real estate owner 100 in an effort to encourage the real estate owner 100 to formally engage the user 102 to market, offer and/or sell the real estate property on the real estate owner's 100 behalf. Thus, the report (206 and 208) may be generated prior to the real estate property being listed on a formal listing service (such as the Multiple Listing Service (MLS)). The user 102 may have been approached by the real estate owner 100 to serve as a listing agent for the owner 100, and may prepare the comparative market analysis report (206 and 208) to display comparable value of the real estate owner's 100 property to display a possible return on sale of the property.

In one embodiment, the user 102 may utilize the methods disclosed herein to receive an offer on a property and present such offer to the real estate owner before, during, or after a listing presentation to the real estate owner.

The user 102 may generate the comparative market analysis report (206 and 208) through use of the user device 104 (marked in FIG. 1). The user device 104 may be configured to communicate with the facilitator 110 to provide the one or more real estate property characteristics of the real estate property to the facilitator 110.

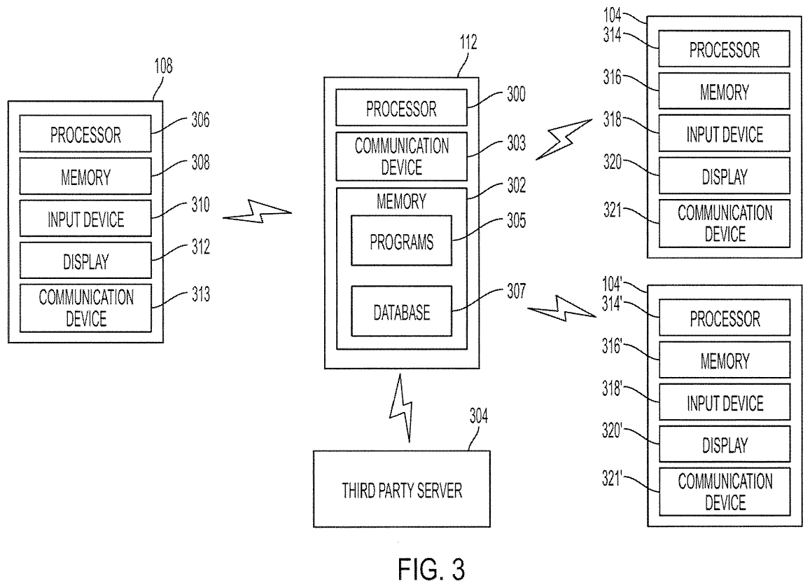

As discussed, the facilitator 110 may comprise a server 112 configured to communicate with the user device 104. The server 112 may be represented in FIG. 3 and may include a processor 300, a memory 302, and a communication device 303 (as marked in FIG. 3).

The communication device 303 may be configured to communicate with other devices of the system, including but not limited to one or more computer devices 108, user devices 104, 104′, and/or third party servers 304. The communication device 303 may allow the server 112 to remotely communicate with other devices of the system, and may comprise an internet port, Ethernet port, modem, wi-fi port, Bluetooth device, network interface controller, or other form of wired or wireless communication device. The communication device 303 may be configured to transmit and receive information from the one or more computer devices 108, user devices 104, 104′ and/or third party servers 304 of the system, and may be configured to route information between the one or more computer devices 108, user devices 104, 104′ and/or third party servers 304 of the system.

The memory 302 may be configured to store information for use in the methods disclosed herein and for use by the processor 300. The information may be stored as data for use by the processor 300. The memory 302 may comprise a hard drive, solid state memory, RAM, ROM, or other form of memory. The memory 302 may be located locally with the server 112, or may be located remote from the server 112 and may communicate remotely with the server 112 via the communication device 303 or the like. The memory 302 may comprise a non-transitory computer readable medium. The computer readable medium may store one or more programs that cause the processor 300 to execute one or more processes disclosed herein. The memory 302 may comprise a non-volatile memory.

The memory 302 may store programs 305 and a database 307. The programs 305 may be configured to be operated by the processor 300. The programs 305 may be utilized to perform the methods disclosed herein, and may include a comparable property search program, a comparative market analysis report production program, a comparison program, a real estate buyer information compilation program, and a user query program. Other programs may be stored in the memory 302 as desired.

The database 307 may include information for retrieval by the processor 300 to perform the methods disclosed herein. The database 307 may include information regarding real estate properties. The information may include real estate property characteristics of real estate properties, such as a location of a real estate property (including address or zip code), the year a property was built, the number of bedrooms or bathroom, square footage, neighborhood, among other real estate property characteristics. The database of information may be populated with information from one or more third party servers 304 (marked in FIG. 3). The one or more third party servers 304 may include servers providing information regarding real estate properties for sale or recently sold, such as the Multiple Listing Service (MLS). The database 307 may be configured to provide real estate property characteristics of multiple real estate properties for use in the comparative market analysis report (206 and 208).

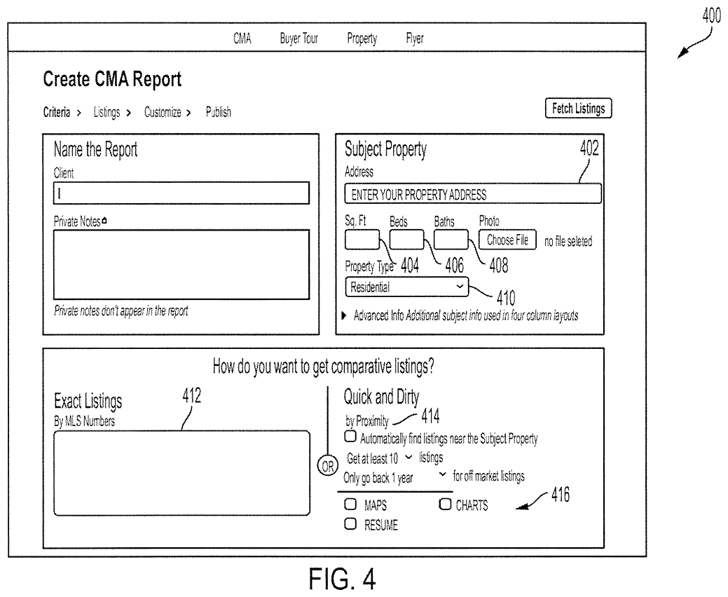

The memory 302 and database 307 may also store one or more forms (such as form 400 shown in FIG. 4) for the user 102 to populate with real estate property characteristics, for use to produce the comparative market analysis report (206 and 208). The forms may be configured for the user 102 to access and retrieve to populate with the real estate property characteristics.

The memory 302 and database 307 may also store content for use to produce the comparative market analysis report (206 and 208). The content may include information such as a resume of the user 102, maps, charts, analysis, suggested list prices, and/or other sales support content. The content may be retrieved by the processor 300 in production of the comparative market analysis report (206 and 208). The content may be selected by the user 102 for inclusion in the comparative market analysis report (206 and 208) prior to the production of the comparative market analysis report (206 and 208). The content may be provided by the one or more third party servers 304 (marked in FIG. 3), which may include servers providing information regarding real estate properties for sale or recently sold, such as the Multiple Listing Service (MLS). The server 112 may retrieve the content from the third party servers 304. The content may also be provided by, or based on information provided by the user 102, and communicated to the server 112. For example, the user 102 may provide information in his/her resume, or may provide his/her resume for storage in the memory 302. The resume may then be retrieved by the processor 300 in production of the comparative market analysis report (206 and 208) if the user 102 would like to include his/her resume in the report (206 and 208).

The memory 302 and database 307 may also store contact information for the user 102. The contact information may be communicated to the server 112 via the user device 104. Multiple contact information for multiple users 102 may be stored in the memory 302 and database 307 as desired.

The memory 302 and database 307 may also store real estate buyer information. The real estate buyer information may include one or more real estate buyer criteria, queries of the real estate buyer 106, and contact information for the real estate buyer 106. The real estate buyer information may be for multiple real estate buyers, and may be stored in the database 307 for each real estate buyer.

The real estate buyer information may be stored in the memory 302 and database 307 based on information provided by the real estate buyer 106. For example, the server 112 may communicate with and interface with a computer device 108 of the real estate buyer 106. The real estate buyer 106 may utilize the computer device 108 to input the one or more real estate buyer criteria, queries of the real estate buyer 106, and contact information for the real estate buyer 106 into the computer device 108. Such information may be transmitted to the server 112.

The one or more real estate buyer criteria may be criteria provided by the real estate buyer 106 to state characteristics of a real estate property that the real estate buyer 106 may be interested in buying. The one or more real estate buyer criteria may comprise real estate property characteristics such as location of a real estate property (including address or zip code), the year that a property was built, and/or price of the property, among other characteristics. For example, the real estate buyer 106 may only be interested in buying property in a certain zip code, and would indicate such a criteria in the real estate buyer criteria.

The queries of the real estate buyer 106 may comprise one or more queries (represented as step 212 in FIG. 2) that the real estate buyer 106 would like to ask the user 102. The queries may be regarding a subject property, and may be queries that allow the real estate buyer 106 to better determine an offer to make on a subject property and whether to make an offer on a subject property. The queries may be specific to each real estate buyer 106 (e.g., a first real estate buyer may have a set of additional queries that are stored and are different than a set of stored additional queries of a second real estate buyer).

The contact information for the real estate buyer 106 may also be provided by the real estate buyer 106.

The real estate buyer information may be provided by each real estate buyer, and may be encoded into the memory 302 and database 307 utilizing the real estate buyer information compilation program stored in the memory 302 (or real estate buyer information compilation unit). The real estate buyer information (the one or more real estate buyer criteria, queries of the real estate buyer, and contact information for the real estate buyer) may be encoded into the database 307 in a format for retrieval and use by the processor 300, and may be designated for each respective real estate buyer. The real estate buyer information may be encoded into the database 307 as a series of lead funnels, which may include the one or more real estate buyer criteria. The queries of the real estate buyer may be added to the lead funnel for the respective real estate buyer. Each lead funnel may be specific for each real estate buyer, and may be utilized to match the information provided by the user 102 with a particular real estate buyer. Each lead funnel may be stored in the database 307 as a separate file for retrieval and processing by the processor 300. The real estate buyer information may be formatted and stored in the database 307 in a structure in which the server 112 is able to process the real estate buyer information in an efficient way. In this way, the computing speed, efficiency, and accuracy of the server 112 may be improved. The data format may be a unique and novel data format that may only be identified and interpreted by the server 112.

The processor 300 may be configured to perform the operations of the facilitator 110. The processor 300 may comprise one or more processors, and may comprise a central processing unit (CPU) or other form of processor as desired. The processor 300 may be configured to execute instructions stored in the memory 302. The instructions executed by the processor 300 may include software associated with the system. The processor 300 may be specifically and specially configured to perform the operations described herein, and in some embodiments, the server 112 may be a special purpose machine for performing the operating described herein.

The processor 300, together with the programs 305, may form a unit for operating the methods of the programs. For example, the server 112 may include a comparable property search unit for operating the comparable property search program, a comparative market analysis report production unit for operating the comparative market analysis report production program, a comparison unit for operating the comparison program, a real estate buyer information compilation unit for operating the real estate buyer information compilation program, and a user query unit for operating the user query program. The units may be dedicated computing units for operating the respective programs, and may comprise hardware, software, or a combination thereof. The units may be special-purpose electronic devices programmed for the purposes described herein.

Continuing to refer to FIG. 3, the computer device 108 may include a processor 306, a memory 308, an input device 310, a display 312, and a communication device 313. The processor 306 may be configured to perform the processes of the computer device 108. The memory 308 may be configured to store information for use by the computer device 108. The input device 310 may comprise a device such as a keyboard, touchscreen, or other form of input device 310 for receiving an input to the computer device 108. The display 312 may comprise a display for displaying information of the computer device 108 (e.g., a screen). The communication device 313 may be configured to communicate with the other devices of the system, such as the server 112, and may comprise an internet port, Ethernet port, modem, wi-fi port, Bluetooth device, network interface controller, or other form of wired or wireless communication device.

The computer device 108 may be configured to be used by the buyer 106 to communicate with the server 112. The computer device 108 may be configured to be used by the real estate buyer 106 to transit the real estate buyer information to the server 112. The real estate buyer 106 may utilize the display 312 and input device 310 to input the real estate buyer information and may utilize the communication device 313 to transmit the real estate buyer information to the server 112. The computer device 108 may also be configured for the real estate buyer 106 to retrieve and view real estate property characteristics of the subject property and responses to queries of the real estate buyer 106. The real estate buyer 106 may view the real estate property characteristics of the subject property and responses to queries of the real estate buyer 106 on the display 312 of the computer device 108. The real estate buyer 106 may utilize the input device 310 to provide a response to the real estate property characteristics of the subject property. For example, the real estate buyer 106 may utilize the input device 310 to indicate interest in the subject property.

The user device 104, similar to the computer device 108, may include a processor 314, a memory 316, an input device 318, a display 320, and a communication device 321. The processor 314 may be configured to perform the processes of the user device 104. The memory 316 may be configured to store information for use by the user device 104. The input device 318 may comprise a device such as a keyboard, touchscreen, or other form of input device 318 for receiving an input to the user device 104. The display 320 may comprise a display for displaying information of the user device 104 (e.g., a screen). The communication device 321 may be configured to communicate with the other devices of the system, such as the server 112, and may comprise an internet port, Ethernet port, modem, wi-fi port, Bluetooth device, network interface controller, or other form of wired or wireless communication device.

The user device 104 may be configured to be used by the user 102 to communicate with the server 112. The user device 104 may be configured to retrieve and transit information to the server 112, for example, via the communication device 321. The user device 104 may be configured for the user 102 to utilize to input information into the user device 104 and transmit such information to the server 112 or other devices of the system. The user device 104 may include a graphical user interface (GUI) that appears on the display 320 and may be interacted with by the user 102 (via the input device 318) to provide selections on the GUI. The user device 104 may be utilized to view information transmitted from the server 112.

The user device 104′ may be similar to the user device 104, and like elements of user device 104′ are indicated with a prime symbol “¹.” User device 104′ is illustrated to represent that server 112 may communicate with multiple user devices 104, 104′, among other user devices.

The processors 306, 314, 314′ may comprise one or more processors, and may comprise central processing units (CPU) or other forms of processors as desired. The processors 306, 314, 314′ may be configured to execute instructions stored in the respective memory 308, 316, 316′. The instructions executed by the processors 306, 314, 314′ may include software associated with the system. The processors 306, 314, 314′ may be specifically and specially configured to perform the operations described herein, and in some embodiments, the computer devices 108, and user devices 104, 104′ may be special purpose machines for performing the operating described herein.

The server 112 may also communicate with multiple computer devices 108 utilized by real estate buyers, and may communicate with multiple third party servers 304. In embodiments, the configurations of the apparatuses shown in FIG. 3 may be varied as desired.

Referring back to the flowchart of FIG. 2, the user 102 may utilize the user device 104 to provide the one or more real estate property characteristics of the real estate property to the facilitator 110 (to initiate step 200). The user 102 may provide the one or more real estate property characteristics of the real estate property to the facilitator 110 in a variety of manners. In one embodiment, the user 102 may utilize the user device 104 to access one or more of the forms that may be stored in the memory 302 of the server 112. For example, the user 102 may use the input device 318 to communicate a request to the server 112 for the forms to be transmitted to the user device 104 and appear on the display 320. The forms may be downloaded to the user device 104 or may be remotely accessed by the user device 104.

In one embodiment, the forms may be pre-stored in the memory 316 of the user device 104. The forms may be for the comparative market analysis. The processor 314 may retrieve one or more of the forms from the memory 316 to receive input from the user 102. In one embodiment, a dedicated program, such as an application or “app” may be stored in the memory 316 of the user device 104 and may be operated or executed by the processor 314 to access the forms from the server 112 or from the memory 316. FIG. 4 illustrates an embodiment of a form 400 that the user 102 may utilize to provide the one or more real estate property characteristics to the facilitator 110. The form 400 may appear on the display 320 of the user device 104. The form 400 may appear on a GUI of the user device 104.

Referring to FIG. 4, the form 400 may include one or more data entry fields 402, 404, 406, 408, 410 for the user 102 to populate with the one or more real estate property characteristics. The data entry fields 402, 404, 406, 408, 410 may request real estate property characteristics such as the subject property address 402, the square footage 404, the number of bedrooms 406, the number of bathrooms 408, and the property type 410. Other real estate property characteristics may be requested as desired. The real estate property characteristics may include a year that the real estate property was built, or a price of the real estate property.

The form 400 may additionally request entry of information regarding how the user 102 would like to provide comparative listings for use in the comparative market analysis report. The user 102 may be able to select exact listings 412, by directly listing comparative properties, and/or may be able to select listings 414 by proximity to the subject real estate property.

The user 102 may utilize the input device 318 to populate the form 400 with the one or more real estate property characteristics.

In embodiments, the form 400 may have a different configuration than shown in FIG. 4. In other embodiments, a form may not be utilized, and the user 102 rather may be able to produce the comparative market analysis report (206 and 208) by otherwise communicating one or more real estate property characteristics to the facilitator 110. The user 102 may utilize the user device 104 to communicate one or more real estate property characteristics to the facilitator 110. For example, the user 102 may be able to use the input device 318 and communication device 321 to send an email or text message (for example, a SMS or MMS or other form of text message) including real estate property characteristics to the facilitator 110, and may automatically receive a comparative market analysis report in response. The user 102 may only input a subject property address in the user device 104, and transmit an email or text message to the facilitator 110 to receive a receive a comparative market analysis report and otherwise initiate the methods disclosed herein.

Referring to FIG. 2, in step 202, the facilitator 110 may determine whether the one or more real estate property characteristics provided for the comparative market analysis meet one or more of the real estate buyer criteria of the real estate buyer 106. This process may include processing the one or more real estate property characteristics received from the user device 104. The one or more real estate property characteristics provided by the user 102 may be transmitted to the server 112 whether input into the form 400, or provided by direct transmission to the server 112 (via an email or text message or another form of transmission).

The process may include comparing the one or more real estate property characteristics with the one or more real estate buyer criteria of the real estate buyer 106. The facilitator 110 may automatically compare the one or more real estate property characteristics provided for the comparative market analysis with the one or more of the real estate buyer criteria of the real estate buyer 106 to determine whether the one or more real estate property characteristics provided for the comparative market analysis meet the one or more real estate buyer criteria of the real estate buyer 106. The comparison program (or comparison unit) stored in the memory 302 may be utilized to compare the one or more real estate property characteristics with the one or more real estate buyer criteria of the real estate buyer 106. The processor 300 may be configured to retrieve the real estate buyer criteria stored in the memory 302 and compare the one or more real estate property characteristics with the buyer criteria. The processor 300 may compare the one or more real estate property characteristics with the information contained in the lead funnel for the respective buyer.

For example, if the data entry field 402 indicates the subject property is in a particular zip code, and the zip code matches the zip code listed in the real estate buyer criteria, then the facilitator 110 may determine that the subject property meets the real estate buyer criteria of the real estate buyer 106. The real estate property characteristics for such a determination may be provided by the user 102, and/or may be retrieved from a separate source such as the third party server 304 or memory 302 shown in FIG. 3. For example, if the real estate buyer criteria indicates interest in property in a particular zip code and prior to a certain year of construction (e.g., year 2005), and the user 102 only provides a property address, then the facilitator 110 may retrieve information regarding year of construction from the third party server 304 or memory 302 (which may contain such information based on the property address). The facilitator 110 may then determine if the zip code and year of construction meet the real estate buyer criteria of the real estate buyer 106.

The facilitator 110 may determine that the one or more real estate property characteristics meet the real estate buyer criteria of one or more real estate buyers. For example, the memory 302 of facilitator 110 may include real estate buyer criteria of multiple real estate buyers, and may make a determination of whether the property characteristics meet the criteria of any or all of the real estate buyers.

The determination step 202 may occur at the back-end of preparing the comparative market analysis report (206, 208), such that the user 102 is not aware that the determination is taking place. The determination step 202 may occur in real-time as the user 102 provides the one or more real estate property characteristics to the facilitator 110.

The facilitator 110 may make a determination of whether to query the user 102 upon the facilitator 110 making the determination 202 of whether the one or more real estate property characteristics meet the one or more real estate buyer criteria. This determination is represented as step 204 in FIG. 2. For example, if the real estate property characteristics do not meet the one or more real estate buyer criteria, then the facilitator 110 may determine to not query the user 102 and may continue to provide a comparative market analysis report 206 to the user 102. This determination is represented by the “no” path in FIG. 2 leading to the comparative market analysis report 206.

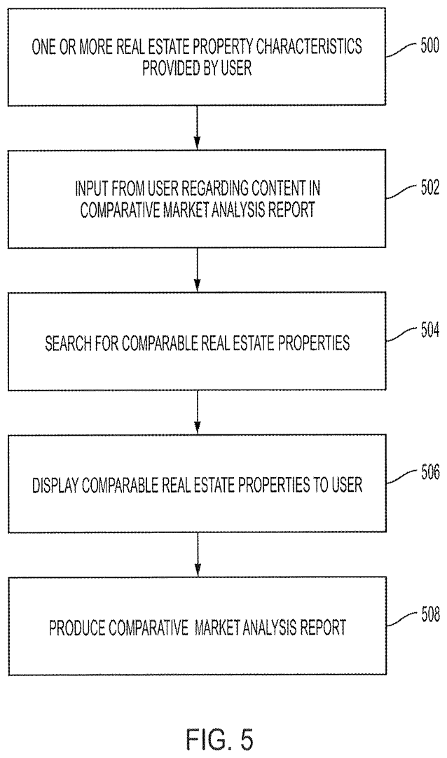

If the user 102 is not queried, the comparative market analysis report may be provided to the user 102. The comparative market analysis report may be provided based on the one or more real estate property characteristics provided by the user 102 for the comparative market analysis. FIG. 5 illustrates steps that may be utilized to produce the comparative market analysis report. The comparative market analysis report may be produced automatically by the facilitator 110 in response to the one or more real estate property characteristics being provided by the user 102. This step is represented as step 500 in FIG. 5. The user 102 may also provide input regarding what content the user 102 would like in the comparative market analysis report. This step is represented as step 502 in FIG. 5. For example, referring to FIG. 4, the form 400 may request entry of information regarding how the user 102 would like to provide comparative listings for use in the comparative market analysis report (marked as reference numbers 412 and 414). The form 400 may also request information regarding whether the user 102 would like content such as a resume of the user 102, maps, charts, analysis, suggested list prices, and/or other sales support content provided in the comparative market analysis report (marked as reference number 416). The user 102 may select the content using the input device 318 of the user device 104, and may transmit such selections to the server 112.

Based on the one or more real estate property characteristics being provided by the user 102, the server 112 may utilize the comparable property search program (or comparable property search unit) stored in the memory 302 to search for comparable real estate properties in the third party server 304 and/or the memory 302. This step is represented as step 504 in FIG. 5. For example, the server 112 may be configured to search multiple third party servers 304 (for example, MLS database) to determine comparable properties. The comparable property search program (or comparable property search unit) may utilize an algorithm to determine properties that are comparable to the subject property based on the one or more real estate property characteristics being provided by the user 102. The search may be performed over the internet and may use a transaction standard that the third party server 304 (such as a target MLS server) supports. The retrieved information for the comparable properties may be stored in the memory database 307, which may comprise a SQL database.

The facilitator 110 may be configured to display the comparable properties retrieved by the comparable property search program (or comparable property search unit) to the user 102 on the user device 104. This step is represented as step 506 in FIG. 5. The user 102 may select or deselect comparable properties to be presented in the comparative market analysis report. For example, the GUI of the user device 104 may present click-boxes or other forms of fields for the user 102 to select or deselect to choose comparable properties to be presented in the comparative market analysis report. The specific comparable properties to be used in the report may be stored in the database 307.

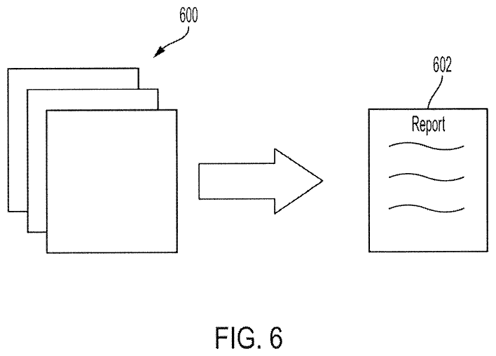

Based on the one or more real estate property characteristics, and the comparable properties, and the content the user 102 may desire in the comparative market analysis report, the facilitator 110 may produce the comparative market analysis report. This step is represented as step 508 in FIG. 5. The facilitator 110 may utilize the comparative market analysis report production program (or comparative market analysis report production unit) stored in the memory 302 to produce the comparative market analysis report. The processor 300 may retrieve the content from the memory 302 based on the selections desired by the user 102. The processor 300 may then compile the comparative market analysis report to include information regarding the subject property, the comparable properties, and the content the user 102 desires in the comparative market analysis report. FIG. 6, for example, illustrates the compilation of the content 600 for inclusion in the comparative market analysis report (represented by reference number 602 in FIG. 6).

The comparative market analysis report may include pages of content regarding the subject property, the comparable properties, and the content that the user 102 desires in the comparative market analysis report. The comparative market analysis report may comprise a document that may be provided to the user 102 and to the user device 104. For example, the comparative market analysis report may be downloaded by the user device 104, may be accessible remotely by the user device 104, or may be otherwise provided to the user 102. The comparative market analysis report may comprise an electronic document which may be viewed on the user device 104 (on the display 320), or may be printed or otherwise provided in paper form to the user 102. The user 102 may bring the user device 104 to the listing presentation with the real estate owner 100 to display the comparative market analysis report on the display 320 of the user device 104.

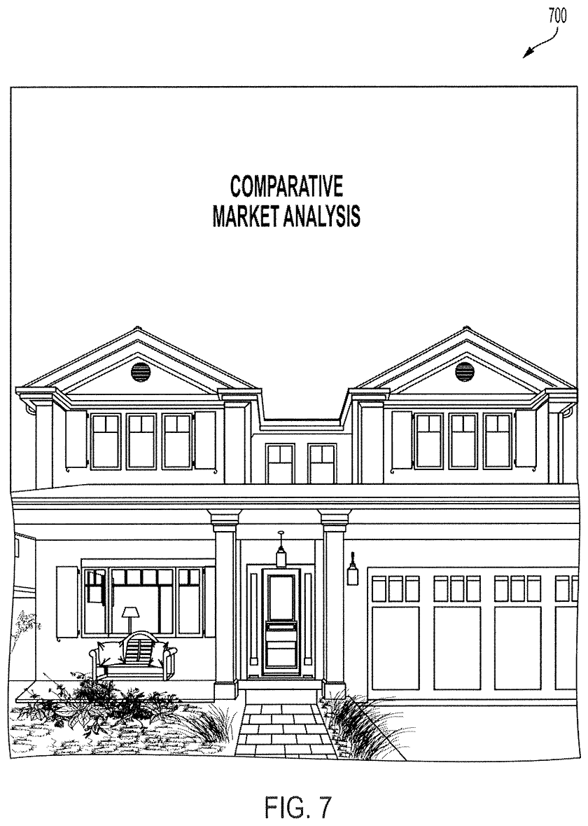

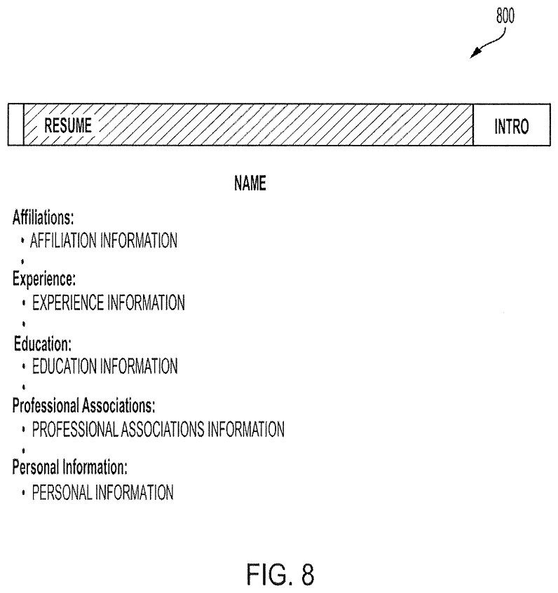

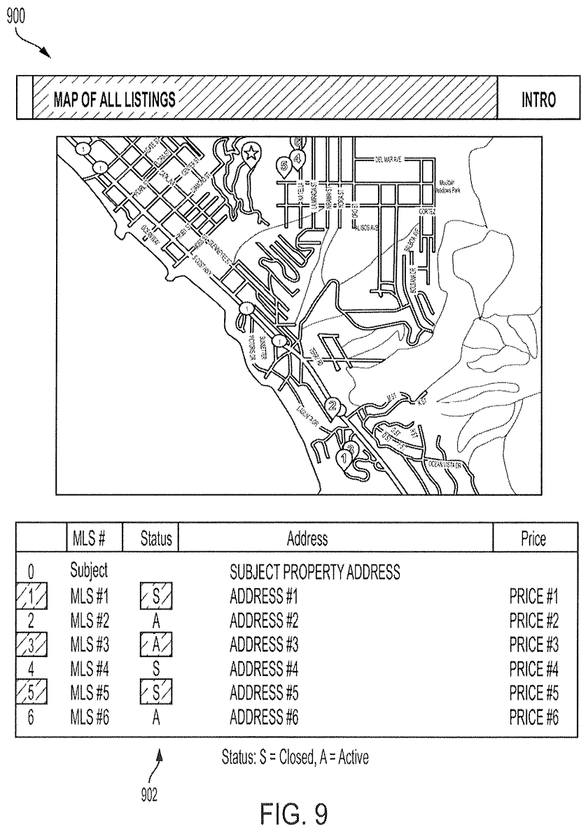

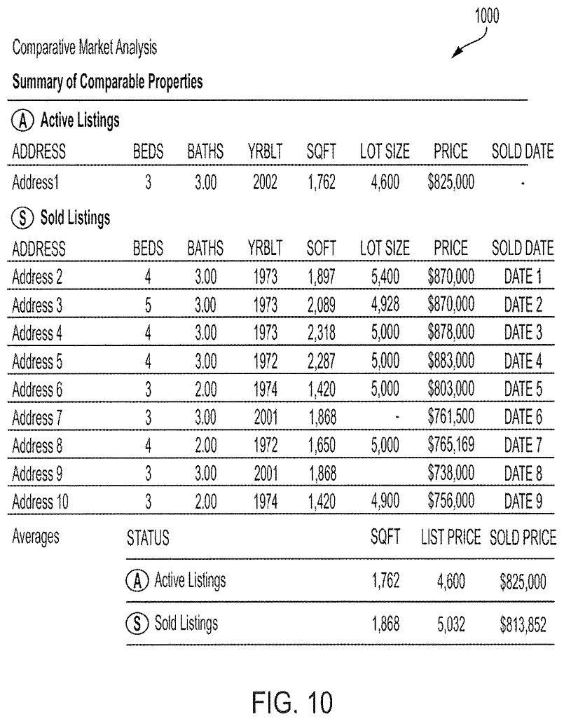

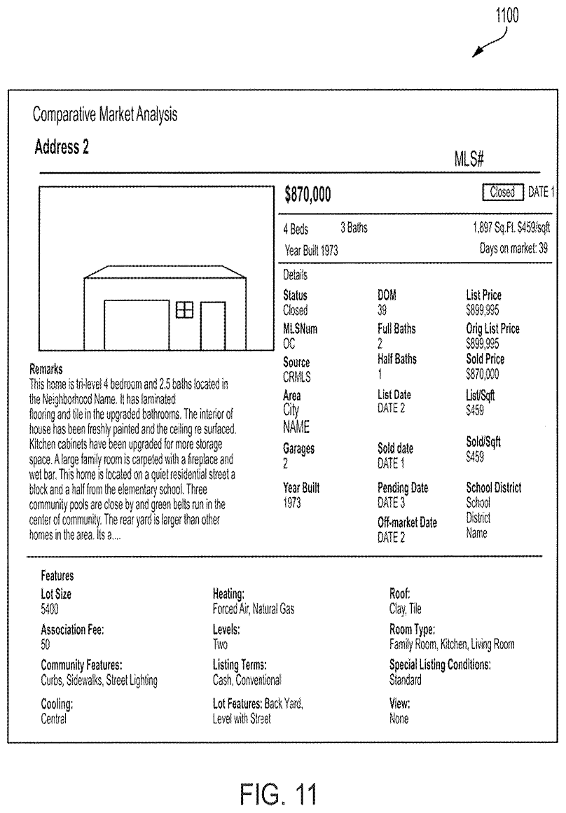

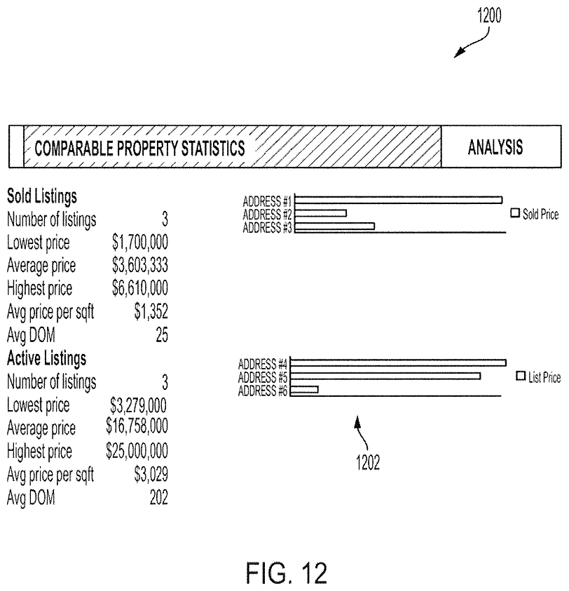

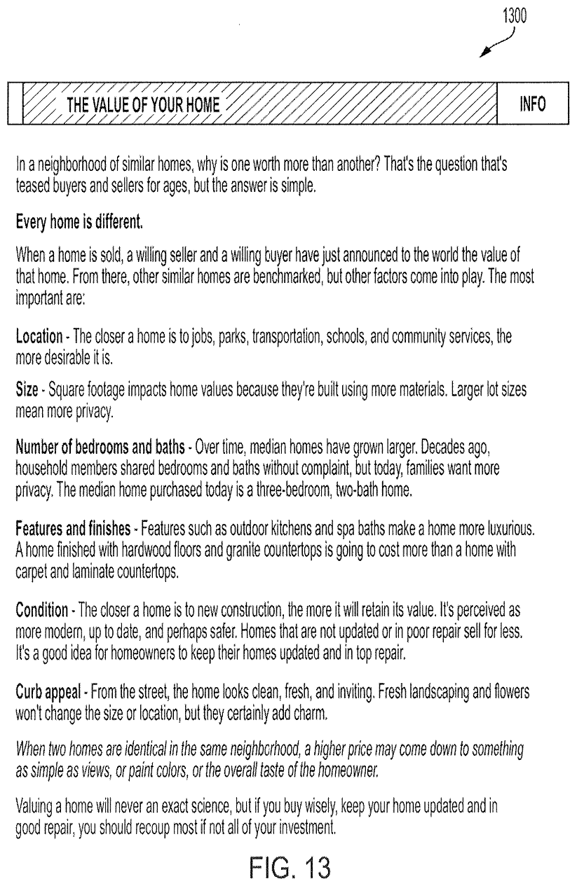

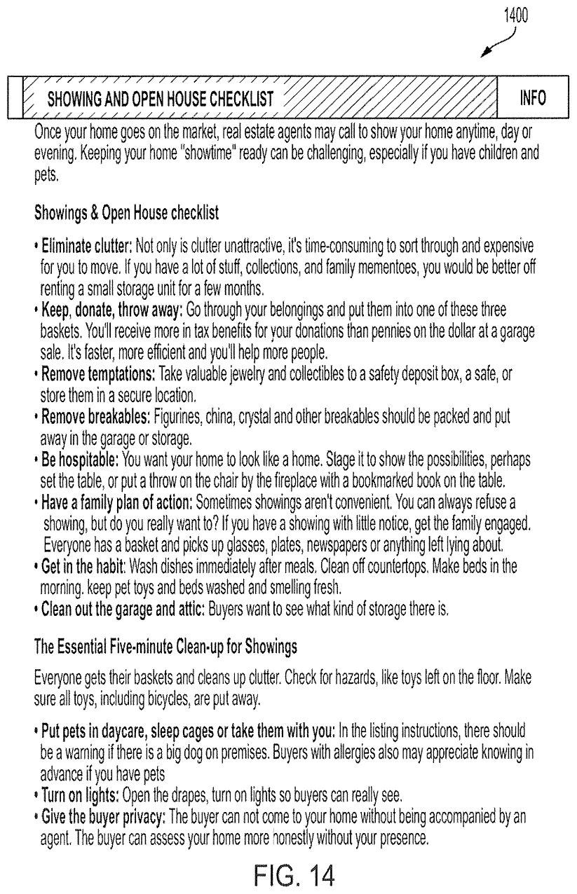

FIGS. 7-14 illustrate example content that may be provided in the comparative market analysis report. The images in FIGS. 7-14 may represent pages that may form the comparative market analysis report. The pages may include a cover page 700 in FIG. 7. The pages may include a resume 800 of the user 102, as represented in FIG. 8. The pages may include a map 900 and summary property information 902, as represented in FIG. 9. The pages may include a summary of comparable properties 1000, as represented in FIG. 10. For example, the summary may include a listing of active listings and sold listings. The pages may include detailed real property characteristics 1100 of a comparable property, as represented in FIG. 11. The pages may include analysis in the form of statistics of comparable properties 1200 and charts of comparable properties 1202, as represented in FIG. 12. The pages may include sales support content 1300, 1400, as represented in FIGS. 13 and 14. The sales support content 1300, 1400 may provide information regarding valuation and sales of a real estate property for use by the real estate owner 100. The content in the comparative market analysis report may vary from the content shown in FIGS. 7-14 in other embodiments.

In one embodiment, the comparative market analysis report may be provided to the user 102 automatically upon receipt of the one or more real estate property characteristics from the user 102. For example, if the user 102 only inputs a subject property address in the user device 104, and transmits an email or text message to the facilitator 110 to receive a comparative market analysis report, then the facilitator 110 may be configured to automatically produce a comparative market analysis report with content based on default settings or settings previously provided by the user 102. The comparable property search program (or comparable property search unit) and the comparative market analysis report production program (or comparative market analysis report production unit) may operate to automatically provide a comparative market analysis report (such as the report shown in FIGS. 7-14) to the user 102 based on receipt of the email or text message.

Referring back to step 204 of FIG. 2, if the facilitator 110 determines that the one or more real estate property characteristics do meet the one or more real estate buyer criteria, then the facilitator 110 may determine to query the user 102 in step 204. The facilitator 110 may determine to query the user 102 if the one or more real estate property characteristics provided for the comparative market analysis meet the one or more real estate buyer criteria of a real estate buyer 106 (rather than not querying the user if the characteristics do not meet the buyer criteria). The one or more real estate property characteristics may meet the one or more real estate buyer criteria of multiple real estate buyers.

The query may be regarding matching the user 102 with the real estate buyer 106. For example, the query may comprise asking the user 102 if the user 102 would like to be matched with the real estate buyer 106. As such, the query may comprise asking the user 102 if the user 102 is to be provided with an offer on the subject real estate property from the real estate buyer 106. The query may request a response, and may be in the following forms: “Would you like to receive a cash offer from a real estate buyer on the subject property”; “Would you like to receive an offer from an iBuyer on the subject property”; “Would you like to arrive at your listing presentation with an offer from an iBuyer”; “Would you like to bring a cash offer to your listing presentation?,” or another form that queries the user 102 regarding matching the user 102 with a real estate buyer 106.

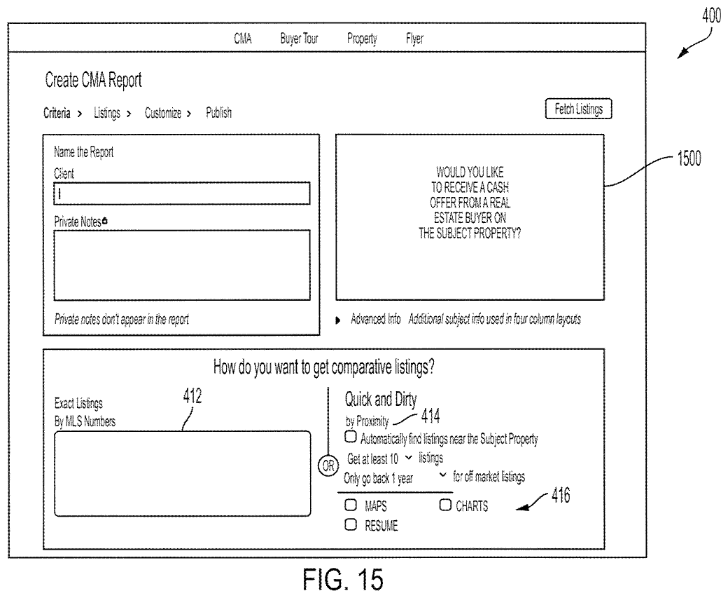

The query may be provided on the user device 104. For example, if the facilitator 110 determines that one or more real estate property characteristics provided for the comparative market analysis meet the one or more real estate buyer criteria of the real estate buyer 106, then the query may pop up on the display 320 of the user device 104. The server 112 may utilize the user query program (or user query unit) stored in the memory 302 to provide the query to the user 102. The server 112 may be configured to transmit the query to the user device 104 such that the query appears on the GUI of the display 320. In an embodiment in which the user device 104 is remotely accessing the server 112, then the server 112 may provide the query on the GUI viewed by the user 102. The query may appear on the form (for example the form 400) viewed by the user 102 upon having populated the form with the one or more real estate property characteristics. The position of the query on the GUI may allow the query to be evident to the user 102. FIG. 15, for example, illustrates the query 1500 appearing on the GUI including the form 400.

In other embodiments, the query may be otherwise provided to the user 102. For example, the query may be transmitted to another screen or portion of the user device 104. A notification such as a pop up, or text message, or email, or other form of notification may be transmitted to the user device 104. The query may be provided in a manner that allows the user 102 to respond to the query.

The user 102 may provide a response to the query. The user 102 may utilize the input device 318 of the user device 104 to provide the response to the query. For example, the user 102 may be provided with a click box or other field to indicate an affirmative or negative response to the query. The user 102 may click “no” or “yes” in response to the query. In one embodiment, the user 102 may respond back to an email or text message to indicate an affirmative or negative response to the query, or transmit another form of response to the facilitator 110. The response may be transmitted by the user device 104 to the server 112 such that the server 112 receives the response.

If the user 102 provides a response in the negative to the query, then the user 102 continues on the “no” path in FIG. 2 leading to the comparative market analysis report 206. Thus, the user 102 receives the comparative market analysis report 206 without being matched with the real estate buyer 106. The comparative market analysis report 206 may be provided to the user 102 in a manner discussed in regard to FIGS. 5-14.

If, however, the user 102 provides a response in the affirmative to the query, then the user 102 continues on the “yes” path in FIG. 2. The user 102 receives the comparative market analysis report 208, which may be the same as the comparative market analysis report 206. The comparative market analysis report 208 may be provided to the user 102 in a manner discussed in regard to FIGS. 5-14. The subject real estate property however, may undergo analysis in step 210 if the user 102 responds in the affirmative to the query.

The analysis in step 210 of the FIG. 2 flowchart may include providing one or more additional queries 212 to the user 102 relating to the real estate property or relating to a transaction of the real estate property. The additional queries 212 may be provided if the user's 102 response to the query in step 204 is affirmative. The server 112 may determine which of the real estate buyers have had their real estate buyer criteria met by the one or more real estate property characteristics provided by the user 102. Based on that determination, the server 112 may retrieve from the memory 302 the one or more queries stored in the memory 302 for that real estate buyer. In embodiments, multiple sets of queries may be retrieved if multiple real estate buyers had their real estate buyer criteria met by the one or more real estate property characteristics provided by the user 102.

The additional queries 212 may ask for additional real estate property characteristics, or may ask for characteristics regarding the real estate owner 100, among other queries. The additional queries 212 may provide the real estate buyer 106 with answers to queries that may be specific to each real estate buyer 106 and may allow the real estate buyer 106 to better provide an offer on the real estate property or determine whether to provide an offer on the real estate property. The additional queries 212 may be questions such as “is the seller/real estate owner expecting market price?”; “is the seller/real estate owner looking for a fast close?”; “did the seller/real estate owner inherent the property?,” among other forms of queries relating to the real estate property. The additional queries 212 may be regarding the subject property (e.g., condition of property, age of property, major components such as the roof, electrical, plumbing) or may be related to a transaction of the real estate property (e.g., does the property owner have an interest in receiving a cash offer?; is the user 102 interested in representing the real estate buyer 106 in a sales transaction of the real estate property?).

The additional queries 212 may be provided on the user device 104 in a similar manner as the query in step 204 of FIG. 2. For example, the queries may pop up on the display 320 of the user device 104. The server 112 may utilize the user query program (or user query unit) stored in the memory 302 to provide the queries to the user 102. The server 112 may be configured to transmit the queries to the user device 104 such that the queries appear on the GUI of the display 320. In an embodiment in which the user device 104 is remotely accessing the server 112, then the server 112 may provide the queries on the GUI viewed by the user 102. The queries may appear on the form (for example the form 400) viewed by the user 102 upon having populated the form with the one or more real estate property characteristics. The position of the queries on the GUI may allow the queries to be evident to the user 102.

In other embodiments, the additional queries may be otherwise provided to the user 102. For example, the additional queries may be transmitted to another screen or portion of the user device 104. A notification such as a pop up, or text message, or email, or other form of notification may be transmitted to the user device 104. The queries may be provided in a manner that allows the user 102 to respond to each of the queries.

Step 214 of FIG. 2 represents the user 102 being matched with the real estate buyer 106. The user 102 may be matched based on the response to the query in step 204, regarding matching the user 102 with the real estate buyer 106. For example, if the user 102 did not want to be matched with the real estate buyer 106 in step 214, then no matching would occur (leading to the “no” path in FIG. 2). The user 102 may be matched with the real estate buyer 106 by determining which real estate buyer 106 had the real estate buyer criteria that met the real estate property characteristics. In one embodiment, the user 102 may provide the responses to the additional queries in step 212 for the one or more real estate buyer 106 that the user 102 is matched with.

For example, the user 102 may provide responses to the additional queries 212. The user 102 may utilize the input device 318 of the user device 104 to provide the response to the queries. For example, the user 102 may be provided with a click box or other field to indicate an affirmative or negative response to each of the queries. The user 102 may click “no” or “yes” in response to the query. In one embodiment, the user 102 may respond back to an email or text message to indicate an affirmative or negative response to each query, or transmit another form of response to the facilitator 110. The responses may be transmitted by the user device 104 to the server 112.

In one embodiment, the responses to the queries may be transmitted to the real estate buyer 106 to which the responses to the queries pertain and to which the user 102 is matched. The responses to the queries may be transmitted to the respective real estate buyer 106 along with the one or more real estate property characteristics provided by the user 102. Other information in the form of the comparable properties of the subject property, information about the user 102, and the subject property tax data, may be provided to the respective real estate buyer 106. The information may be transmitted to the computer device 108 of the matched real estate buyer 106 and viewable on a display 612 of the computer device 108. The server 112, for example, may utilize an applicable programming interface (API) that is utilized to communicate the information to the matched real estate buyer 106 in a computer readable format. In an embodiment in which multiple real estate buyers are matched with the user 102, for example having criteria that are met by the subject property, multiple transmissions may be made of the information to the respective matched real estate buyers. The information may be transmitted to the respective matched real estate buyer 106 for the matched real estate buyer 106 to make a determination of whether to make an offer on the subject property and what price to offer. The information may be electronically bundled together before being transmitted to the matched real estate buyer 106. In one embodiment, the real estate buyer 106 may be alerted to a match by posting the information via a JavaScript Object Notation (JSON) to a Uniform Resource Locator (URL) that the real estate buyer 106 defines on the internet. The information may be transmitted directly to the real estate buyer's 106 workflow software (via the computing device 108) or a human data analysis may process the data. In one embodiment, the information may be transmitted to the real estate buyer 106 via email.

In one embodiment, the additional queries 212 may be standardized for all real estate buyers, or may be determined by the facilitator 110. For example, the additional queries 212 may not be provided by the real estate buyer 106 and may be provided by the facilitator 110 as queries to determine information regarding the real estate property or the potential real estate property transaction that may be useful for a real estate buyer.

In one embodiment, the server 112 may store in the memory desired responses to the additional queries 212. The desired responses may be determined by the facilitator 110 or may be previously provided by the respective real estate buyer 106. In such an embodiment, the server 112 may be configured to automatically determine whether the responses to the additional queries 212 by the user 102 meet the desired responses and whether the user 102 should be matched with the respective real estate buyer 106. If the server 112 determines that the responses do not meet the desired responses, then the server 112 may determine that the user should not be matched with a real estate buyer 106 and may provide the user 102 with the comparative market analysis report 208 without matching the user 102 with a real estate buyer 106. The comparative market analysis report 208 may be provided to the user 102 in a manner discussed in regard to FIGS. 5-14 without matching the user 102 with a real estate buyer 106.

If however, the server 112 determines that the responses to the additional queries 212 meet the desired responses, then the server 112 may determine that a matching should occur and transmits the responses to the queries to the matched real estate buyer 106 to which the responses to the queries pertain. The responses to the queries may be transmitted to the respective matched real estate buyer 106 along with the one or more real estate property characteristics provided by the user 102, and other information, as discussed previously.

If the user 102 is matched with a real estate buyer 106, the matching process may include providing the responses to the additional queries 212 of the user 102, and/or the one or more real estate property characteristics provided by the user 102, and/or other information in the form of the comparable properties of the subject property, information about the user 102, and/or the subject property tax data to the real estate buyer 106. Other matching processes may be utilized. For example, matching may include providing contact information of the user 102 to the real estate buyer 106, and/or by providing contact information of the real estate buyer 106 to the user 102. The contact information may be transmitted to the user device 104 or the computing device 108, or both. The user 102 may submit contact information to the facilitator 110 during the process of initiating or completing the comparative market analysis report, for example in step 200 of FIG. 2. In other embodiments, other forms of matching may occur, for example, by the facilitator 110 automatically providing a telephone call between the user 102 and real estate buyer 106, or by otherwise notifying the user 102 and/or real estate buyer 106 of the interest of one or both of the parties in engaging with the other. The notification may be transmitted from the server 112 to the user device 104 and/or computer device 108 and may appear on the displays 320, 312 of the respective user device 104 and computer device 108 as a pop up or other form of notification.

Preferably, the facilitator 110 concludes the involvement in the process once the matching occurs. The facilitator 110 preferably does not engage in any business discussions between the matched real estate buyer 106 and user 102, and allows the matched real estate buyer 106 and user 102 to arrive at an offer to be provided on the subject real estate property. The communication between the buyer 106 and user 102 is indicated as step 216 in FIG. 2 (which the facilitator 110 is preferably not involved in) and as line 114 in FIG. 1.

The server 112 may also provide the comparative market analysis report 208 to the user 102 in a manner discussed in regard to FIGS. 5-14.

In certain embodiments, the user 102 may then arrive at a listing presentation with the real estate owner 106, having the comparative market analysis report 208 as well as an offer on the property from the real estate buyer 106. In an embodiment in which the real estate buyer 106 is an iBuyer, the offer may accordingly be provided by an iBuyer and may be for a cash offer and a relatively prompt close. In embodiments, the offer may be provided before, during, or after the listing presentation.

The user 102 may also be able to represent the real estate buyer 106 on the buyer side of a transaction involving the real estate property. The user 102 may engage the real estate buyer 106 to represent the buyer 106 upon being matched with the buyer 106 according to methods herein. The user 102 may represent the buyer 106, the real estate owner 100, or both.

In certain embodiments, the user 102 may be matched with multiple real estate buyers 106, and may accordingly acquire multiple offers on the subject real estate property to present the real estate owner 100.

The systems, apparatuses, and methods disclosed herein may beneficially provide an improvement in matching real estate buyers with users. Users may more easily become aware of potential real estate buyers and may be able to present offers to real estate owners during listing presentations. In addition, the computer processing involved in creating the comparative market analysis reports and matching real estate buyers with users provides an improved computing method.

The methods disclosed herein may not only be utilized with current real estate properties for sale, but may also be utilized by a user 102 with expired or dead real estate listings. For example, the user 102 may supply the real estate property characteristics of an expired or dead real estate listing to the facilitator 110 and determine potential real estate buyers in the expired or dead property.

In one embodiment, the processes disclosed herein may be embodied on a non-transitory computer readable medium that may store a program causing a processor to execute the processes disclosed herein.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only, and is not intended to limit the scope of systems, apparatuses, and methods as disclosed herein, which is defined solely by the claims. Accordingly, the systems, apparatuses, and methods are not limited to that precisely as shown and described.

Certain embodiments of systems, apparatuses, and methods are described herein, including the best mode known to the inventors for carrying out the same. Of course, variations on these described embodiments will become apparent to those of ordinary skill in the art upon reading the foregoing description. The inventor expects skilled artisans to employ such variations as appropriate, and the inventors intend for the systems, apparatuses, and methods to be practiced otherwise than specifically described herein. Accordingly, the systems, apparatuses, and methods include all modifications and equivalents of the subject matter recited in the claims appended hereto as permitted by applicable law. Moreover, any combination of the above-described embodiments in all possible variations thereof is encompassed by the systems, apparatuses, and methods unless otherwise indicated herein or otherwise clearly contradicted by context.

Groupings of alternative embodiments, elements, or steps of the systems, apparatuses, and methods are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses an approximation that may vary, yet is capable of performing the desired operation or process discussed herein.

The terms “a,” “an,” “the” and similar referents used in the context of describing the systems, apparatuses, and methods (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the systems, apparatuses, and methods and does not pose a limitation on the scope of the systems, apparatuses, and methods otherwise claimed. No language in the present specification should be construed as indicating any non-claimed element essential to the practice of the systems, apparatuses, and methods.

All patents, patent publications, and other publications referenced and identified in the present specification are individually and expressly incorporated herein by reference in their entirety for the purpose of describing and disclosing, for example, the compositions and methodologies described in such publications that might be used in connection with the systems, apparatuses, and methods. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

What is claimed is:

1. A method of matching a user with a real estate buyer, the method comprising:
determining, with a processor, whether one or more real estate property characteristics provided for a comparative market analysis meet one or more real estate buyer criteria of the real estate buyer;
querying the user based on the determination;
receiving a response to the query by the user; and
matching the user with the real estate buyer based on the response to the query.

2. The method of claim 1, wherein the one or more real estate property characteristics include a location of a real estate property, a year that a real estate property was built, or a price of a real estate property.

3. The method of claim 1, wherein the one or more real estate property characteristics are provided by the user.

4. The method of claim 3, wherein the user is a real estate professional.

5. The method of claim 4, wherein the user is a listing agent.

6. The method of claim 3, wherein the one or more real estate property characteristics are provided for the comparative market analysis by being entered in a form for the comparative market analysis by the user.

7. The method of claim 6, wherein the form is provided on a user device and includes one or more data entry fields for the user to populate with the one or more real estate property characteristics.

8. The method of claim 7, wherein the processor automatically compares the one or more real estate property characteristics populating the one or more data entry fields with the one or more real estate buyer criteria of the real estate buyer to determine whether the one or more real estate property characteristics provided for the comparative market analysis meet the one or more real estate buyer criteria of the real estate buyer.

9. The method of claim 1, wherein the processor is of a server, and the server includes a memory storing the one or more real estate buyer criteria of the real estate buyer.

10. The method of claim 1, wherein querying the user based on the determination includes, if the one or more real estate property characteristics provided for the comparative market analysis meet the one or more real estate buyer criteria of the real estate buyer, querying the user.

11. The method of claim 10, wherein querying the user based on the determination includes providing a query to the user on a user device regarding matching the user with the real estate buyer.

12. The method of claim 11, wherein the query is regarding whether the user is to be provided with an offer on a real estate property from the real estate buyer.

13. The method of claim 1, further comprising providing one or more additional queries to the user regarding a real estate property or a relating to a transaction of the real estate property if the response to the query by the user is affirmative.

14. The method of claim 1, wherein the step of matching includes providing contact information of the user to the real estate buyer or providing contact information of the real estate buyer to the user.

15. The method of claim 1, further comprising providing a comparative market analysis report to the user based on the one or more real estate property characteristics provided for the comparative market analysis.

16. A system for matching a user with a real estate buyer, the system comprising:
a server configured to:
determine whether one or more real estate property characteristics provided for a comparative market analysis meet one or more real estate buyer criteria of the real estate buyer,
communicate a query to a user device based on the determination,
receive a response to the query by the user device, and
match the user with the real estate buyer based on the response to the query.

17. The system of claim 16, wherein the server is configured to provide a comparative market analysis report to the user device based on the one or more real estate property characteristics provided for the comparative market analysis.

18. The system of claim 16, wherein the server is configured to automatically compare the one or more real estate property characteristics populating one or more data entry fields with the one or more real estate buyer criteria of the real estate buyer to determine whether the one or more real estate property characteristics provided for the comparative market analysis meet the one or more real estate buyer criteria of the real estate buyer.

19. A non-transitory computer readable medium storing a program causing a processor to execute a process comprising:
determining whether one or more real estate property characteristics provided for a comparative market analysis meet one or more real estate buyer criteria of a real estate buyer;
querying a user based on the determination;
receiving a response to the query by the user; and
matching the user with the real estate buyer based on the response to the query.

20. The non-transitory computer readable medium of claim 19, the process further comprising providing a comparative market analysis report to the user based on the one or more real estate property characteristics provided for the comparative market analysis.
